(19) United States
(12) Patent Application Publication
(10) Pub. No.: US 2018/0331838 A1
(43) Pub. Date: Nov. 15, 2018

(54) SYNCHRONIZATION METHOD, REPRESENTATION THEREFOR AND ASSOCIATED SUBSCRIBER DIRECTORY

(71) Applicant: Dexpa UG (haftungsbeschraenkt), Stade (DE)

(72) Inventor: Markus ALBRECHT, Stade (DE)

(21) Appl. No.: 15/575,565

(22) PCT Filed: May 20, 2015
(86) PCT No.: PCT/DE2015/100201

§ 371 Date: Jul. 6, 2018

(51) Int. Cl. H04L 12/18; H04L 12/58

(52) U.S. Cl. CPC H04L 12/1818; H04L 51/22; H04L 51/20; H04L 51/043

(57) ABSTRACT

A synchronization method between at least two subscribers (TN1, TN2, TNx) of at least one asynchronous event (E) between the subscribers (TN1, TN2, TNx) in relation to temporally synchronized events (E), a representation of a/the synchronization process and/or individual steps of a/the synchronization process on a digital communication device (DC) and to subscriber directory for a synchronization method, wherein the subscriber directory is digitally stored in a computer-aided synchronization location (SY).

The invention concerns a method of synchronization between at least two participants of at least one asynchronous event between the participants to time-synchronized events, a representation of a method of synchronization and/or individual steps of a synchronization method(s) on a digital communication device and a subscriber directory for a synchronization method, the subscriber directory being digitally stored in a computer-based synchronization center.

The following is an explanation of the terms used:

Asynchronous events in the sense of this invention are to be understood as: in particular telephone conversations, meetings, telephone conferences, personal parcel/postal deliveries, scheduling, advertising inquiries, consultations and the like.

Asynchronous and synchronous in the sense of the invention are to be understood as:

Asynchronous event means that a first subscriber has a time-schedulable, scheduled and/or predictable, as well as short-notice (e. g. in the event of an emergency) desire to speak with at least one second subscriber, to deliver something to him/her, to make a phone call, to sell something or to carry out a consultation, or to receive one of these services from a second subscriber, although it is completely unclear when the second subscriber has time for this, taking into account his/her personal appointment situation.

Synchronous event means that the asynchronous event request takes place between the at least two subscribers, taking into account the personal appointment situation of at least the second subscriber, in particular of both subscribers, e. g. a telephone conversation between the two subscribers takes place, without there being a busy signal or the called party's mailbox being answered, as well as an indication that the subscriber to be reached is currently not available or that a packet is being delivered.

The following sections explain in detail the asynchronous events to be synchronized, the problems and the associated tasks, which are at least taken into account by this inventive process:
telephone conversations

The most important event is the telephone call, which is completely covered by the fundamental functions of the synchronization method. This includes a telephone call between a first subscriber and at least one second subscriber, wherein the first subscriber wants to call the second subscriber. Here the problem is already evident, i. e. does the second subscriber have time for the first subscriber, does the second subscriber have any time at all for the first subscriber, does the second subscriber have time for communicating between 12:00 and 16:00, for example. All these questions could until now only be answered by the first party calling the second party and hoping that there is no busy signal from the second party, so that the call can actually take place. However, it is possible that the called second party will not be able to accept the call from the first party so that the call does not take place. For example, the first party's telephone call would be recorded on the voicemail, answering machine or in the secretary's office of the second party, because the second party is unavailable, is already in an appointment or simply does not want to speak to the first party.

Contemplating this set of problems and also the experiences of one's own life, the problem of the busy signal or the inability to get a dial tone or the difficulty of reaching subscribers for telephone conversations becomes apparent, so that the task of the invention is to eliminate busy signals as well as mailboxes and answering machines, so that one can say, in the final analysis, that every conference, when synchronized, actually does take place.
Meeting/appointment, potentially with personal attendance

Another event is a gathering or a meeting between at least two parties, which is also covered by the basic functions of the synchronization method. For example, a first party would like to meet at least one second party in order to talk to him/her about a specific topic. For example, the second party might be particularly busy, so the parties involve their employees, who try to sort the corresponding requests by email or telephone into the personal schedule of the second party, so that in this case the communication via a third party is necessary to set up the appointment.

The same applies, for example, to visits to doctors and the like, where the first subscriber, a patient, wants to arrange an appointment with the second subscriber, i. e. the doctor, and only with the involvement of the physician's assistant on the telephone can an appointment be scheduled. The situation is similar for lawyers who want to be visited by clients. Other such constellations include, for example, insurance agents and customers, car salesmen and customers, delivery services (home delivery service, pizza delivery service, etc.), etc.

As an alternative to scheduling appointments and meetings via telephone or email, in each case scheduling, that is, synchronizing, them via third parties, it is also possible to send email inquiries with set deadlines and subjects of interest to the respective persons and to store these appointments in a groupware solution or a computer-supported database after confirmation by the second party. For this purpose, it is already possible in the state of the art to see the free and occupied times of the second subscriber, but only if the second party allows the first party to do so, which will never happen with unknown persons.

Another example would be the negotiation of a case before an office in which two parties would have to be summoned to the office and these parties would have to be synchronized.

The next example is the delivery of parcels, where everyone knows the problem that the parcel deliverer rings and nobody is at home. This asynchronous event must urgently be synchronized, even taking into account only the ecological requirements, namely environmental pollution caused by motor vehicles and the like, it would seem to be necessary that a parcel delivery is actually made at the first attempt at delivery. This requires synchronization of the presence of the recipient, i. e. the second subscriber, and the delivering company, in particular the deliverer, the first subscriber, who would like to actually deliver the package to be delivered and who needs a precise indication of time to do this.

Practical experience shows, and everyone knows this from their own experience, that it is not easy to make an appointment with another person. In particular, the busy signal or the lack of conectivity is a big annoyance.

It can be concluded that, in the sense of the invention, an event means that at least two subscribers, i. e. persons, want to connect with each other. This should be done when it suits both subscribers.

State-of-the-art technology offers various possibilities for synchronizing events between at least two people, i. e. subscribers. As an example, reference may be made to the above-mentioned embodiments, namely groupware solutions with server and client basis, secretarial telephonists, logistics planners, everything involving e-mail and telephone enquiries with corresponding confirmation by the other subscriber themselves or their representative.

For example, it is possible to agree to a communication between two persons via telephone exchanges and corresponding employees; however, the problem is that the employees of such telephone exchanges may in circumstances not have a full overview of the personal scheduling situation of the persons wishing to communicate, so that the need for follow-up enquiries with the persons themselves can arise.

The problems in the state of the art are essentially the above-mentioned problems, namely in particular the complexity of reaching someone, especially when they are very busy.

In particular, it was recognised that in the case of state of the art event scheduling procedures there is no possibility of circumventing or completely ignoring the busy signal, the inaccessibility, for example due to radio gaps in the mobile network, unplanned absence due to illness, and the like.

The present invention is concerned with the task of connecting people with each other, i. e. synchronizing different asynchronous events between at least two subscribers, wherein the individual subscribers of the method of synchronization for asynchronous events do not have to communicate their actual schedules to the other subscribers, not even if they have explicitly free periods, since an unplanned call might also be received, but only have to transmit their individual accessibility and availability to participate in particular events to a centralized computer-supported synchronization center. Thus, it is the aim to connect at least two subscribers who want to reach each other, if it suits both subscribers, without the subscribers having to know the explicit free times and otherwise committed times of the other subscribers.

This task is solved with a method of synchronization according to the main claim, as well as further by the associated illustrations and a subscriber directory according to the subordinate claims.

The special features of the invention are described below:

The method of synchronization to temporally synchronize into a synchronized event at least one asynchronous event between at least two subscribers includes the following steps:
digitally sending an event request from a first subscriber to a computer-based synchronization center, wherein the event request has at least the following parameters:
   reference number of the first subscriber,
   time window for taking place of the asynchronous event,
   identity and/or a reference number and/or at least one assignable/referenceable parameter and/or property of the at least one second subscriber,
   event status, which must correspond to the subscriber status of the at least one second subscriber or the subscriber status of all of the subscribers selected to participate in the event,
referencing of the event according to the event request of the first subscriber via the computer-based synchronization center, taking into account the transmitted parameters;
entering the event in an event table in the computer-based synchronization center;
checking and determining the subscriber status and/or checking for changes in the subscriber status;
continuous and/or repetitive checking of the events in the event table for agreement and/or fulfilment and/or fulfilability of the parameters of the events of at least the essential participants for the event, whereby, in the case that all the parameters are in agreement and/or fulfilled and/or fulfilable, at least one digital transmission of the now possible event to the participants of the event takes place and the event is synchronized.

The transmission of the first subscriber's referencing number is the simplest and most sensible way to identify ones-self as the sender via a digital communication device, which the first subscriber can use for communication with the computer-based synchronization center, whereby the personal referencing number, as it were, represents his identification number in the system.

When creating subscribers in the system, an identification procedure is preferably used in which the subscribers can be referenced uniquely. In particular, it should also be possible to use personal user names, which is optional.

Digital transmission is usually carried out via a digital network, which is implemented, for example, via the Internet with the corresponding protocols or the telephone network and the like. In a preferred configuration, the communication between the subscribers and the computer-supported synchronization center is particularly secure, in particular encrypted.

The corresponding arrangement of the events has already been mentioned at the beginning of this article, especially telephone conversations (especially preferred), personal attendance dates, deliveries and the like.

The event request must have either the identity of the second subscriber, such as first and last name, or the place of residence, the identification/reference number and/or at least one assignable/referenceable parameter and/or properties of the at least second subscriber, so that it can be referenced by the computer-based synchronization center, i. e. can be assigned to a second subscriber. These assignable/referential parameters and/or characteristics may include, for example, the professional title (physician, roofer, transporter, lawyer, etc.), qualifications/skills (especially experience in the field of family law of a lawyer, certifications, etc.), open capacities (to carry out the event, such as the renovation of a roof, advice in the field of industrial property rights, etc.), special characteristics with regard to ownership of the property.

With regard to the event status for the event, at least the second subscriber must be in the moment of the event in the subscriber status selected by the first subscriber. An appropriate subscriber status in this respect may be that the subscriber is at the time working, can be reached privately, is at home or has the opportunity to come to the first subscriber, for example. Further examples of subscriber status are described below, with combinations of the individual subscriber statuses, such as “working at home” or “private” and “work” being possible.

When selecting the subscriber or selecting the parameters/properties of the at least second subscriber, the first subscriber has the option of selecting an appropriate subscriber from an inventive (see claim 15) subscriber list and sending them to the computer-based synchronization center. In this case, the corresponding parameters and properties for the subscriber can be stored in the subscriber directory, but also the possible subscriber status or corresponding event status of the at least second subscriber can be stored, so that a corresponding subscriber status or event status can be suggested by the computer-based synchronization center via the subscriber directory, taking into account the desired event of the first subscriber.

When transmitting the event request, a time window in which the asynchronous event is to take place must also be specified. This window of time is chosen in the largest possible case from now until it never ends. Other possible options are, for example, in the next four days, within the next two weeks or in two hours, and so on. As a rule, the wish of a first subscriber for the event to take place should normally lie within a limited period of time. For example, a first subscriber would like to discuss a business topic with a second subscriber today or talk privately to someone about something, so that time windows are always useful, which are then taken into account by the computer-based synchronization center.

The event is referenced according to the parameters and/or properties transmitted with the event request, whereby the at least second subscriber is determined by the computer-based synchronization center.

As soon as the necessary subscribers for the event are known, the event is stored, entered and/or saved in an event table within the computer-supported synchronization center. This event table can be either a global event table that contains all events of the method of synchronization and all subscribers, a subscriber-specific event table assigned to the respective subscribers or other database-specific event table forms.

The computer-supported synchronization center has a database system in which all events and subscribers can be stored and linked to each other with all relevant information regarding the subscribers and the events.

The computer-based synchronization center shall comprise at least one computer arrangement or, in particular, a server arrangement, at least one computer or server being provided to implement the computer-based synchronization center. It is particularly recommended that the computer-based synchronization center consists of several computers or servers. Furthermore, it is preferable that the database system is also implemented on several computers or servers for optimal performance distribution. In this respect, the servers can be located remotely from each other and exchange information with each other. The database systems can be synchronized with each other, so that the entire computer-supported synchronization center is fail-safe and performance bottlenecks are avoided.

The checking and recording of the subscriber status or the checking for changes to the subscriber status is carried out continuously by the computer-supported synchronization center. The computer-supported synchronization center can exchange the subscriber status or corresponding subscriber status profiles or relevant time specifications via a network connection with the digital communication devices, which is available at least temporarily, and store them in the computer-supported synchronization center or the database system. In a simple way, the digital communication device can transmit the subscriber reference number and the subscriber status, for example in the form of digits, at regular intervals or it can be transmitted explicitly at the time of the change.

Digital communication devices shall mean in particular mobile phones, smartphones, tablets, voice over IP telephones, computers, servers, telephones, telephone systems, videoconferencing systems and the like, whereby communication with these devices shall be possible for at least the transmission of event requests, in particular with regard to events such as telephone calls, video conferences and the like, this shall also be possible through the digital communication device. Each subscriber can also have several digital communication devices to register on this device, even at different locations, and to connect to the computer-based synchronization center. It is also possible, for example, to create a corresponding profile at pure computer workstations, for example, so that planned telephone calls can be made via a specific telephone to which the subscriber has access in the immediate vicinity of his or her location. An example of this is a telephone with a computer workstation adjacent to it, which is well known in the state of the art, from which the subscriber informs the computer-supported synchronization center that he can currently make telephone calls via the adjacent telephone. For a first subscriber who requests an event, such as a telephone call with a second subscriber, it does not matter from which telephone the second subscriber wants to make a call, since the computer-supported synchronization center synchronizes the event accordingly and thus also sets a connection to the telephone of the second subscriber in accordance with the specifications of the second subscriber.

Finally, the event table is checked continuously and/or repeatedly to see whether events can be fulfilled, taking into account the parameters of the events. If an event that is entered in the event table can be executed, in particular taking into account the parameters for the event, at least one message from the computer-based synchronization center is sent to the participants of the event indicating that the event can now take place. Ideally, the subscribers are either connected or the subscribers are requested to establish a connection, either directly dialing the other subscribers (this is, of course, only done by one subscriber, since otherwise both subscribers might have the busy signal again), in particular the connection is connected or realised by the computer-based synchronization center. This means that the asynchronous event is synchronized successfully at the end of the day, exactly when both subscribers have time for each other at the required moment so that the event can take place.

The method of synchronization between at least two subscribers of at least one asynchronous event between the subscribers to events synchronized in time, may be designed accordingly, alternatively or in particular complementary, wherein
a computer-based synchronization center with
   at least one database system, and
   at least one event table and/or at least one user-specific event table is stored in the database system and events are assigned to the relevant subscribers in this event table;
each subscriber has at least one digital communication device, the digital communication device being connectable and/or connected at least temporarily to the computer-based synchronization center via a network connection;
each subscriber or group of subscribers is assigned at least one referencing number, which is stored in the computer-based synchronization center and/or the database system and is linked to a subscriber and/or group of subscribers;
a time-changeable/selectable/configurable/plannable and/or calculable subscriber status and/or a subscriber status profile is assigned to each subscriber, the subscriber status and/or the subscriber status profile on digital communication device(s) being selectable and/or furnishable by the subscribers, at least the currently and/or last selected subscriber status or the subscriber status profile of all subscribers being stored in the computer-supported synchronization center and/or the database system, the subscriber status being at least two different statuses; for which the method of synchronization has for this purpose the steps:
digital transmission and/or sending of an event request from a first subscriber by means of the digital communication device of the first subscriber to the computer-based synchronization center with at least the following parameters:
   the reference number of the first subscriber;
   a time window for the asynchronous event to take place;
   the identity and/or a reference number and/or at least one assignable/referenceable parameter and/or property of the at least second subscriber and
   an event status, which must correspond to the subscriber status of at least the second or all subscribers selected to carry out the event;
investigating the at least second subscriber by the computer-based synchronization center of the information of the identity and/or the reference number or at least one assignable/referenceable parameter/property transmitted by the first subscriber;
entering the asynchronous event in the event table and/or event table(s):
checking and recording the subscriber status and/or checking for changes to the subscriber status;
ongoing and/or repetitive checking of the events of the event table for agreement and/or fulfilment and/or fulfilability of the parameters of the events of at least the necessary subscribers for the event, wherein
if the parameters are in agreement and/or fulfilment and/or at least one digital transmission of the now possible event is made by the computer-based synchronization center to the subscribers participating in the event to their digital communication devices and the event is synchronized; and/or
at least one digital transmission of the possible event is made by the computer-based synchronization center to the subscribers participating in the event on their digital communication devices and the event is pre-synchronized, the continuous and/or repetitive checking of the events being continued by the computer-based synchronization center until the event is synchronized or the event can no longer be synchronized.

Subscribers can also be grouped together in groups. Subscriber groups can be departments of a company, for example. Whole company structures can be represented as subscribers. Each subscriber may have at least one referencing/identification number, whereby, for example, a subscriber with two professions, such as a full-time employee and a part-time insurance broker, may have two referencing numbers.

The subscriber status of each subscriber can be configured, preselected, changeably scheduled, made planable or calculated by the subscriber themselves or by other subscribers. One can create entire time profiles of the subscriber status of the subscribers. For example, a subscriber can select that he/she starts work at 8:00 AM and is at work until 12:00 noon, cannot be reached for business from 12:00 noon to 1:00 PM, and can then resume his/her office work from 1:00 PM to 5:00 PM. If a subscriber has to leave his or her workplace at short notice due to urgent human needs, he or she can simply select on his or her digital communication device that he or she will not be available for the next 15 minutes, for example. Furthermore, the computer-supported synchronization center can also determine by regularly recording the subscriber status that a subscriber is currently not reachable and thus the subscriber status is set as not reachable for system-related reasons and is entered accordingly when the synchronization of events is taken into account.

As a further configuration of the synchronization method, it is possible to determine an event time window and/or a chronological sequence for the event by the computer-based synchronization center and/or the database system, whereby at least the following steps are carried out:
checking and/or determining the next possible status overlap time for which at least the subscriber status of the at least second subscriber or the subscriber statuses of the subscribers correspond to the event status, wherein this checking and/or determining can or will be carried out anew in the event of a changing subscriber status of at least one of the subscribers, wherein:
   in the case of an overlapping time status and free time within the overlapping time status, the event is entered as a synchronized event with specification of an event time window taking into account the free time in the event table and/or subscriber-specific event tables and/or digitally sent by the computer-based synchronization center to the subscribers participating in the event on their digital communication devices;
   in the absence of the existence of an overlapping time status or free time within the time window for the asynchronous event to take place as an asynchronous event, the event is marked as an asynchronous event, the event is still to be synchronized and/or sent as a request to the at least second subscriber by means of a digital transmission of the event, in particular as a request for confirmation, by the computer-based synchronization center to the digital communication devices of the at least second subscriber.

An event time (estimated call/event time) is determined by the computer-supported synchronization center and can be transmitted to the subscribers or their digital communication devices, whereby this virtually synchronized event is preferably displayed in a preview window (prestream) on the digital communication device.

When determining a time window for the event to be synchronized, at least one prioritization of the event to be synchronized and then an insertion among events already entered in the relevant subscriber event tables or the event table takes place, where
prioritization of the events that have already been synchronized is carried out as required and/or
an event(s) to be synchronized shifts one or more events that have already been synchronized and entered in the event tables of the subscribers, if the priority is higher than the priority of the events that have already been entered in the event tables of the subscribers.

The events can be prioritized with at least the following parameters:
the priority of the event from the point of view of the at least one requesting subscriber;
specified event status, whereby each subscriber status has a corresponding value; as well as optional further selectable/pre-set parameters:
an assigned priority of the event from the point of view of the at least one requested subscriber,
VIP status of the subscriber(s),
an average evaluation of the inquiring subscriber, wherein the average evaluation includes at least the last 10 to 20 event evaluations, wherein an event evaluation at the end of an event which has taken place is queried by the synchronization center with the event participants, and an event evaluation is made available by the subscribers taking into account at least one of the evaluation criteria of the synchronization center:
   reliability of the use of the method of synchronization over the past time, whereby the time of use of the method of synchronization is registered in the synchronization center;
   the quality of the event's content by assigning a personal evaluation on a content-related quality scale specified by the synchronization center;
   benefit and result of the event by assigning a personal evaluation on a benefit and result scale specified by the synchronization center;
   subscriber index, optionally according to individual subscriber status, whereby the subscriber index includes the entire event evaluations;
   subscriber group index, according to individual subscriber status as required, whereby the subscriber group index includes the entire event evaluations;
   number of events executed;
   number of multisubscriber events executed, whereby a higher prioritization occurs the more multisubscriber events were performed;
   regularly recurring events, whereby for two subscribers between which events are frequently synchronized the prioritization is higher;
   the earliest possible time of the event from a specification of the requesting subscriber;
   latest possible time of the event from a specification of the requesting subscriber;
   verage duration of the inquiring subscriber in the required event log of the past/a time interval;
   confirmation status of subscribers, whereby the synchronization center can request events and wait for their confirmation, and a large number of requests that have not yet been confirmed leads to a reduction in priority;
   interval between an event request and an event confirmation;
   planned duration of the event;
   average duration of past events between planned subscribers;
   past observance of the planned duration of the event or the planned duration of the event with a tolerance or mutual consent of the extension of the event;
   local proximity of the subscribers, with a higher prioritization of regionally denser subscribers;
   business function of one/all subscriber(s), in particular selectable from the appropriate functions of management, skilled employee, specialist, sales, service;
   correspondence of the subscribers' languages;
   the quality of any necessary technical digital transmission path;
   correspondences of own interests, offers, products, resources of the subscribers;
   integration and/or use of personal future planning of the subscriber(s) and instruction to the synchronization center.

Prioritization of the events that are pending or will occur in the future is carried out according to their highest relevance for the subscriber. The order or priority of the events, in particular telephone calls and the like, can be suggested and would then be processed accordingly. Of course, the subscriber has the possibility to manually adjust the sequence suggested by the computer-based synchronization center. The parameters can have different weightings ranging from 1 to 50%, whereby it is generally advisable to try to value as many of the parameters as possible accordingly, whereby weightings in the range of 1 to 30% are likely to be the rule. The prioritization with the corresponding parameters can differ in the overall weighting due to the different situations of the subscribers. For example, the result of prioritization can also depend on the attention situation and the attention-reality or ability to act of the subscribers. For this purpose, a subscriber driving a car can only write to a limited extent, so that although telephone calls are possible as events, there is a condition that the driving subscriber cannot write and may not be allowed to write under certain circumstances. If a subscriber moves within an office, he or she can, for example, perceive events that may occur along the way within his or her office, such as conversations with employees and the like. For this purpose, the computer-supported synchronization center can also prioritize open events at short notice in a different way and request them to directly fulfil the event, for example, for direct communication, if this is possible in the time window. This means that events can be dependent on movement, speed of movement, desired mode or local environment, such as volume, accessibility of tools and materials, such as a PC, which might have to be available for an event.

For the event to be synchronized, a probable event time can be determined, namely when the participants of the event will have time, wherein determining the probable event time can include at least the following parameters:
earliest possible time for the event according to input of the first and/or all subscribers;
latest possible time for the event according to input of the first and/or all subscribers;
current subscriber status of the subscribers and planned duration of the current subscriber status

as well as optional further selectable/pre-set parameters:
known switching time to the required subscriber status, taking into account set switching times, daily/weekly/holiday/absence planning;
average duration of an event of the subscriber(s) based on the events carried out so far by the subscriber(s) and/or events carried out previously between the subscribers relevant for the event;
expected switchover time to the required subscriber status of the subscribers, whereby an evaluation is carried out on the basis of the previous subscriber status history and/or the subscriber status profile;
a prioritization of the event—specified by the subscriber(s) and/or determined in accordance with the procedure referred to in claim 5;
accessibility of the subscribers taking into account the response behaviour of the events carried out so far;
location of subscribers and/or planned locations;
number of subscribers;
remaining time within the day;
remaining time within the day for the necessary event status;
time zone of the subscribers;
workload of the subscribers, whereby an evaluation of at least the work/rest hours is carried out as a work-life balance ratio;
tolerance standby of subscribers for prolongation/reduction/overrunning of events and/or subscriber status.

The weighting of the individual factors ranges from 5 to 40%, in particular in the range of 20 to 40% for necessary parameters and between 5 and 20, maximum 30% for optional parameters. This determines the most likely time of the call, when the subscribers will have the event or will communicate with each other, or when the synchronized event could be possible. It is necessary to be able to reach all relevant subscribers in the specified mode, wherein on the basis of the switching times communicated by the subscribers or also predicted switching times for their individual subscriber status and taking into account the evaluation of previous subscriber behavior with regard to their subscriber status profile, an expected time for the event can be determined by the computer-based synchronization center.

The subscriber status or status profile of one or more subscribers for future times can be determined by the computer-based synchronization center based on past subscriber status or a subscriber status profile of the past. For this purpose, the computer-supported synchronization center can take into account the previous behavior with regard to switching the subscriber status of individual or all subscribers and predict the switching with corresponding probabilities. The subscriber status can be set manually by the subscriber himself/herself, by externally positioned transmitters, person-related transmitters taking into account subscriber-specific physical characteristics and/or body conditions, geo-tagged, varying in time and/or by other subscribers.

External locally positioned transmitters are transmitters that transmit a signal on a subscriber's digital communication device by means of radio, near-field communication or the like, or cause a corresponding change of the subscriber status, whereby these transmitters can be arranged, for example, in a restaurant, a meeting room or, for example, in a bathroom and can automatically change the subscriber's status, so that this subscriber can no longer be disturbed at the moment of activation, for example, when he or she wants to go out for dinner.

Personal transmitters can be, in particular, acquisition systems that record and/or monitor the body characteristics and/or body conditions specific to the subscribers. Body conditions and physical characteristics are, for example, blood pressure, fatigue, stress, overload or unconsciousness. Depending on the state of the body or the presence of certain physical characteristics, the status of the subscriber can be changed automatically. For example, if a subscriber is frustrated, the computer-based synchronization center could offer this subscriber to make three quick and promising calls, re-prioritising and quasi-preferring them so that the subscriber's condition may improve.

In this respect, other subscribers, such as the secretary or spouse, may also change the status of a subscriber, preferably with the consent of the subscriber.

A subscriber status can also be changed regularly or irregularly, for example as a result of shift schedules.

It is also possible to adjust the status of the subscribers by taking into account the location or the change in the location, in particular by means of geopositioning sensors or systems.

Subscriber-specific events can be automatically transmitted and/or requested by a subscriber's digital communication device on the basis of their personal subscriber status/subscriber condition to the computer-based synchronization center, whereby the events are at least caused by the digital communication device and/or at least one additional device with sensors for and/or detection of the subscriber-specific status, health status and/or a subscriber-specific situation and corresponding subscriber-specific parameters/characteristics of the subscriber for the event can be transmitted to the computer-based synchronization center by the digital communication device of the subscriber.

In this respect, for example, it could be that the digital communication device recognises the status of the subscriber itself or via additional devices, that the subscriber is hypoglycemic and, as an event, automatically transmits an event request to the computer-based synchronization center, whereby, for example, a pre-selected pizza from the nearest delivery service is to be delivered at short notice. This event request would be able to reference the computer-supported synchronization center accordingly, which would eventually result in the state of the first subscriber returning to normal.

As a further example, the digital communication device could also set an emergency call as an event in case of a fainting situation of the first subscriber, whereby the computer-based synchronization center could, for example, alert other subscribers in the area of the first subscriber in addition to the alarming of an emergency physician, whereby this emergency would receive the absolute highest prioritization for the alerted subscriber, who can act as first responder.

Events can be specified by the computer-based synchronization center, wherein for this purpose at least one subscriber after sending a topic- and/or parameter-related event request as a result digitally receives a suggestion from at least one other subscriber with given topics/parameters and for this purpose at least the following parameters are used:
evaluation of successful events, wherein for the evaluation of an event, each event after completion is mutually evaluated by at least the two subscribers, in particular an evaluation on a scale from 0 to 5 and/or the average of the evaluation of the last events;

as well as optional further selectable/preset parameters, selected from:
number of times per day in the last weeks a subscriber has been in one and/or more status;
regionality, whereby contacts in the closer range, especially up to 20 km, are given a higher weighting;
number of events without postponement/rejection, with a smaller number being preferred;
duration of the planned event, whereby shorter events receive a higher value;
adherence to planned event duration, in particular with adherence to a tolerance;
agreement in terms of topics and interests identified by the subscribers in advance and/or predetermined topics;
agreement in relevant issues or interests identified by the computer-based synchronization center;
available resources for the event, available times and/or available resources of offered services of the proposed subscriber;
same industry or services as the proposed subscriber's industry; quality/relevance of events, services and/or resources; offer of paid services, such as call minutes and/or payment per minute.

The above-mentioned parameters are given values between 1 and 50%, with the general valuation rate being between 1 and 10%.

For example, the first subscriber would indicate as an event request that he or she would like to receive a possible new business partner or contact person with whom he or she would most likely be able to establish new and successful business or business relationships. If the first subscriber makes such an event request, he or she can first receive offers and select from these offers. The subscriber can also generally set times when other subscribers are confronted with advertising. For example, a HEIMFROST frozen goods delivery service could, for example, set up advertisement consultation to subscribers who are open to new offers.

Of course, a synchronized event can also be shifted or blocked at short notice by one or both subscribers within the synchronization method. For this purpose, alternative suggestions can be made directly or accepted by the computer-based synchronization center. However, this postponement or short-term cancellation of events should be virtually impossible, even though it is possible due to surprising influences.

The computer-based synchronization center may optionally request subscribers to specify whether an event should take place at a certain time before the event is finally synchronized, and it is also possible for subscribers to specify the corresponding times for an event on their digital communication devices.

It is also possible that the computer-supported synchronization center may request a response from the at least second subscriber before entering the event in an event table or at least before synchronizing the event, whether the latter wishes to speak to the first subscriber in general, at a certain time, or whether, for example, a deputy for this subscriber should be made aware of the event. For example, a heavily burdened employee of a company could either reject the request completely or forward it to another colleague or representative as required.

If an event is synchronized, it is possible for the subscribers to connect with each other by telephone, for example, whereby in order to prevent busy signals, only one subscriber can be prompted by the computer-based synchronization center to initiate the call.

In an event request, parameters that can be specified as parameters or transmitted include: the event start time, the event end time, the time window for the event to take place, the planned event duration, a desired priority of the requesting party for the event (e. g. 1 to 5 or 1 to 10 or high-low), the subscriber data of the requesting party, a system priority of the requesting party, the topic possibly with details thereof, the type of event, for example business or personal, as well as optional parameters, such as weather conditions, vacations, availability, price, traffic, etc.

In addition, subscriber-specific default settings for incoming events can be selected by the subscribers, so that, for example, a scheduled time for telephone calls or meetings and the like is only automatically confirmed if they are within the specified limits, and are otherwise rejected automatically and the requesting subscriber is requested to shorten the duration of the event. For example, one might need a quick and relevant informational communication by means of which both subscribers are able to make a decision for or against a procedure as quickly and soon as possible.

Subscribers can be evaluated within the method of synchronization or system by the computer-based synchronization center on the one hand and by the other subscribers on the other. On the one hand, it is possible to request an evaluation of the event, e. g. of a telephone call, by both subscribers after an event, especially if the two subscribers were not yet known to each other. In particular, this would include the quality of the telephone call, its content rating and length. The system can also evaluate corresponding events, such as telephone calls, wherein the call duration, a comparison with the planned telephone duration, a reaction to the connection of the two subscribers and any resulting events are included in the evaluation.

In addition, it is possible to generate personal subscriber rankings in which it is possible to record how important another subscriber is for you personally, so that, for example, he or she receives a higher prioritization of requests for events. In addition, personal evaluations of the events that have taken place can be included here.

Another way to send a first, or even already topic-related, contact event request is to have a link on Internet pages that automatically generates an event, for example, a request for a phone call, information or documents. As an example, a first subscriber wants to have information about a particular model on a car manufacturer's website and at the same time also wants to arrange a test drive at the nearest car dealer, whereby the computer-based synchronization center forwards or synchronizes this event request to the nearest car dealership based on the location of the first subscriber. Such codes in the form of QR-codes, numbers on business cards, email signatures or hashtags are equivalent to work with.

In order to introduce a method of synchronization worldwide, digital communication devices in the telephony and video or audio communications sector can first of all use the conventional system and then use the new system. Ultimately, all communication devices with telephony or video/audio communication should be able to be configured in their basic function for the new synchronization method.

With regard to the time limited event requests that expire at a particular time, the subscriber can intervene manually as required before such an event is completely deleted and cause a subscriber-specific prioritization so that this event still takes place.

It is also possible to make a request to the computerized synchronization center to find out when it is best to conduct business and/or conversations with business partners or to hold events, depending on the evaluation of the events that have occurred and the attendee's behavior.

Before the event is synchronized or during carrying out of the event, with the help of digital communication devices between the subscribers, a payment for a service during the event and/or a payment for the event can be agreed upon.

For this purpose, it is advisable to offer a corresponding payment service, via which the subscribers can settle for services. If both subscribers have accepted a corresponding service contract, for example for a consultation with a lawyer, a corresponding charging for the event, for example a consultation interview by telephone, takes place on a per-minute basis. Other events may be, for example, a conversation with an important person such as celebrities, musicians, politicians, athletes who agree to accept event requests for corresponding hourly rates and to hold events with other subscribers, such as telephone conversations, meetings and the like. Other special advantages of the invention are, among others:

In the event of danger or an emergency, which is communicated to the computer-based synchronization center SY, the possibility of informing other subscribers in the appropriate area of the event and of prompting the subscribers to leave a building in the event of a fire, or to provide medical assistance in the event of a medical emergency, or to assist in the search for a person. This can be done by means of geo-positioning, whereby the geo-position of the subscribers could be permanently communicated to the computer-based synchronization center SY.

Furthermore, using known positions of the subscribers, it is possible to send an event request to the subscribers within a certain radius and to offer these subscribers an event if they are in a certain subscriber status. For example, a retail store could offer certain offers to subscribers, if these subscribers so wish and are located in the immediate vicinity of the store. In addition, a home supplier, for example for frozen food, could tell subscribers in a residential area that the home supplier is currently in the residential area and is willing to deliver appropriate products to subscribers' homes.

All of this promotes sustainability from ecological, economic and social aspects.

This also makes person to person communication more important in synchronizing an event, so that postal or electronic (email/messaging) requests in particular can be dispensed with. Only relevant communication is carried out, in which attention of the individual subscribers can be concentrated or focused.

For example, subscribers may choose to accept advertisements from certain other subscribers and also for example to get paid for them. On the basis of an evaluation of corresponding events, a corresponding ranking of the subscribers can also be entered in the computer-supported synchronization center SY or determined and stored by it.

In particular, this type of method of synchronization is also of great importance for service requests to companies, since it can completely dispense with being placed on hold and, for example, synchronize an event by transmitting appropriate parameters, such as a problem description. For example, a customer tries to complain about a faulty product that he has purchased online by sending a corresponding event request to the manufacturer and the computer-based synchronization center SY synchronizes a corresponding event, in this case a telephone call or even an exchange.

A representation of the subscriber-specific events on the subscriber-specific digital communication devices is carried out in such a way that events are displayed at least in part of a display of the digital communication device, whereby
fixed and/or scheduled events are displayed chronologically on a time scale and/or on a time line,
optional events and/or event requests that have not yet been synchronized, in particular those that have been pre-prioritized, prioritized, suggested in terms of time and/or events that have been pre-priorized by the computer-based synchronization center, and/or events that have been predetermined in terms of time and/or sequence, are displayed next to the fixed and/or scheduled events.

Beyond this, it becomes possible to solve the technical problem of displaying events that have not yet been precisely scheduled or synchronized, since for the first time it is possible for the subscribers to visually recognize on technical devices all future events that affect them.

The representation of the events takes place as a circle and/or sphere, preferably with a coloured design, pictures, texts, specification of value and/or other evaluation parameters, wherein different sizes of the individual event representations for the importance of the event are preferred.

A synchronization method(s) and/or individual steps of a synchronization method(s) are represented on a digital communication device, at least in a portion of the display of the digital communication device, wherein a future-oriented time/time scale with events is represented, the events being fixed in time, flexible and/or proposed by a computer-based synchronization center.

A further aspect of the invention is a subscriber directory for the synchronization method, the subscriber directory being digitally stored in a computer-based synchronization center, subscribers being stored by means of a referencing number, and parameters/properties being stored for the subscribers, the parameters/properties being changeable by the computer-based synchronization center by at least individual process steps of a synchronization method.

In particular, this creates the possibility of creating a relevant directory of subscribers, whereby evaluations of subscribers after successful events are used to create a ranking of subscribers so that subscribers who wish to contact other subscribers can indicate in the directory that events to be synchronized are offered only to good or very highly rated subscribers.

The particular advantage of this directory in combination with the method of synchronization is that no telephone numbers need to be published in the conventional sense, but only the events that are requested. This is because a referencing is made by means of an event request and a direct connection is established, for example, for a telephone call between two subscribers.

In addition, group memberships of the subscribers can also be stored, enabling complete company structures to be displayed.

In the following, examples of the implementation of the invention are described in detail using the enclosed drawings in the description of the figures, whereby these are intended to explain the invention and should not be regarded as restrictive:

There is shown in:

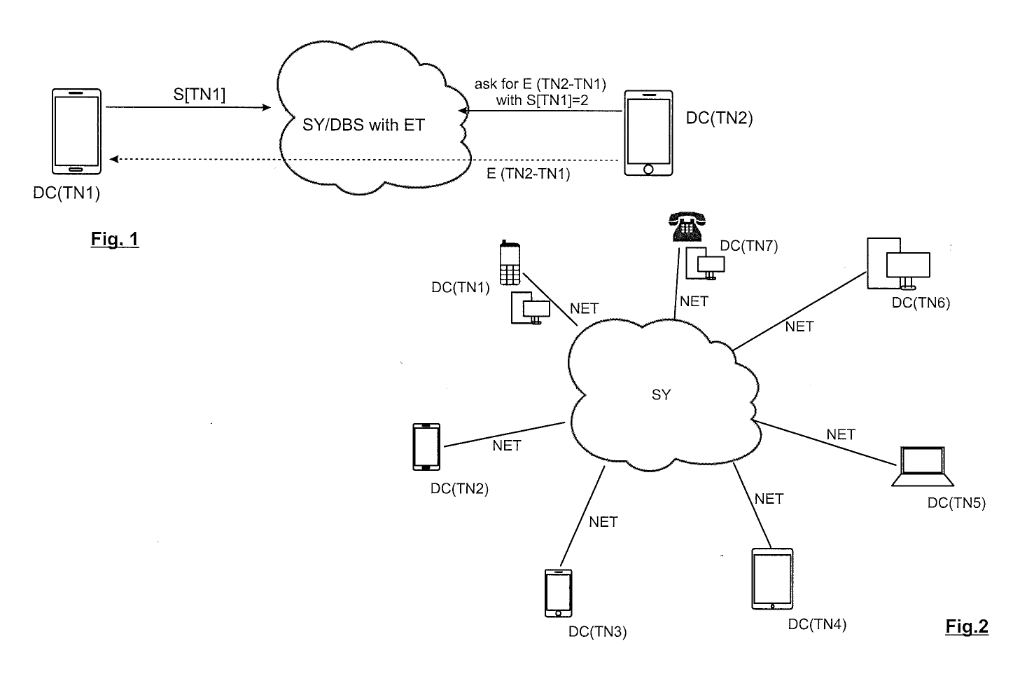

FIG. 1 a schematic representation of the basic design of the inventive synchronization method;

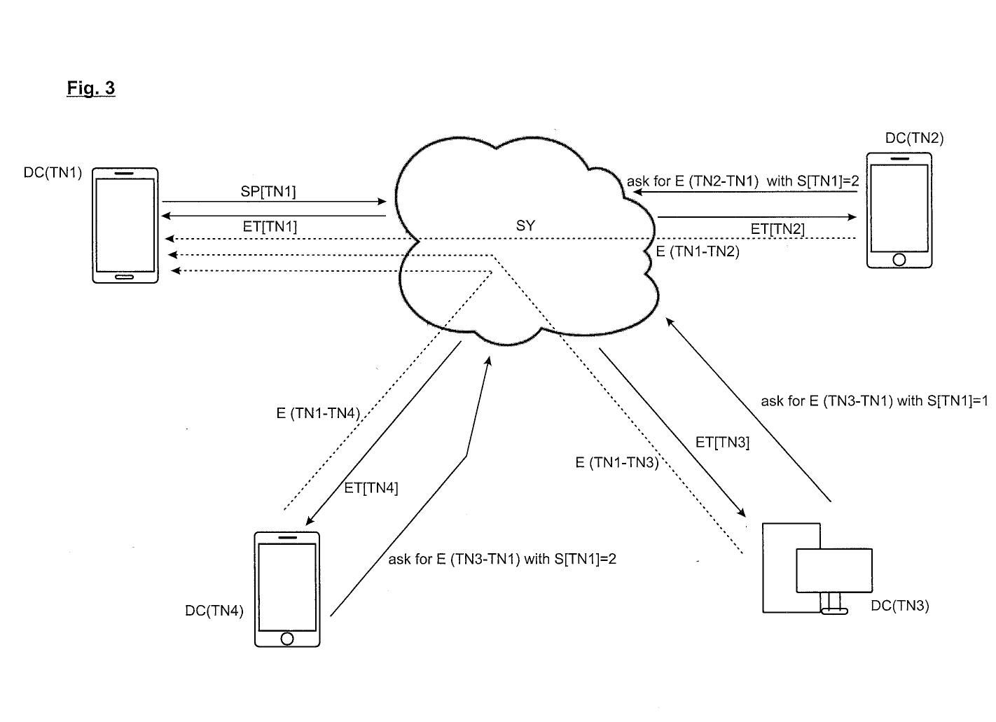

FIG. 2 a schematic representation of the device structure and its interconnection;

FIG. 3 a schematic representation of the process flow of the inventive synchronization method;

FIG. 4 a first schematic representation of a display of the inventive synchronization method on a display of a digital communication device and

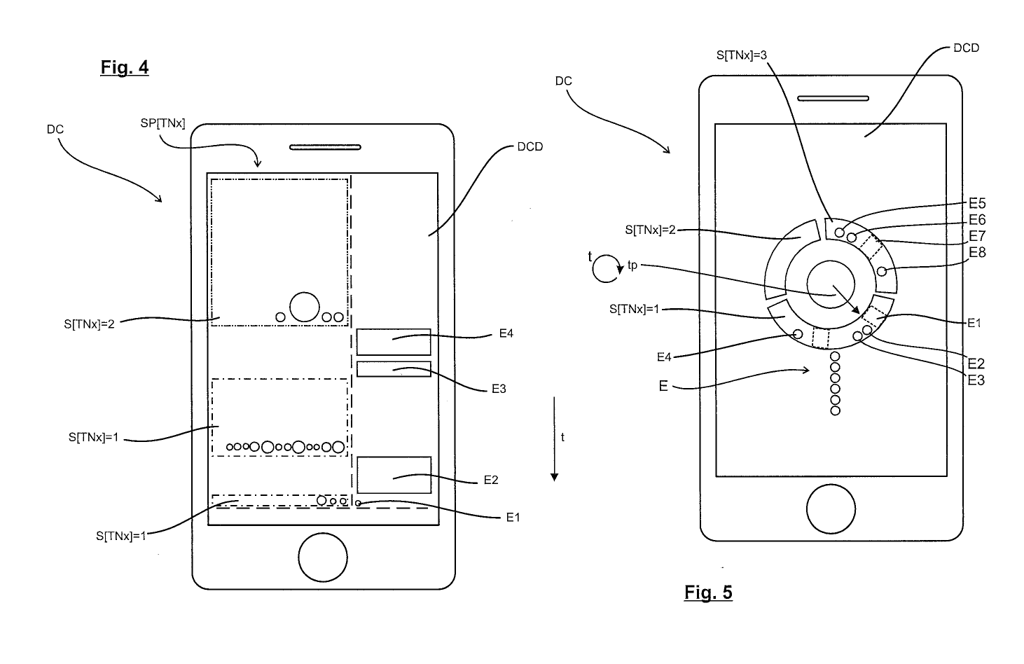

FIG. 5 a second schematic representation of a display of one of the, or the, inventive method of synchronization on a display of a digital communication device.

In FIG. 1, a schematic representation of the basic design of the inventive method of synchronization is shown.

In the basic version, two digital communication devices DC, namely a first smartphone of a first subscriber DC(TN1) and a second smartphone of a second subscriber DC(TN2), are represented, with each connected via a network connection NET, for example the Internet, with a computer-supported synchronization center SY, which in this version is equipped with a database system DBS and on which an event table ET is provided.

By means of the first digital communication device, the subscriber status of the first subscriber S[TN1] is transmitted to the computer-supported synchronization center SY, so that the computer-supported synchronization center SY is aware of the current subscriber status S[TN1] of the subscriber TN1.

The second subscriber sends a request for an event E(TN2-TN1) via its digital communication device DC(TN2) to the computer-supported synchronization center SY, whereby the necessary subscriber status S[TN1]=2 is also transmitted, wherein the number two in the case stands for the subscriber status, for example, private, so that the subscriber 1 must be in the status private for the execution of the event.

Now the event request E (TN2-TN1) is entered and synchronized by the computer-supported SY synchronization center, so that the event can take place within a time window specified by the subscriber 2.

FIG. 2 shows a schematic representation of the device configuration of the necessary devices DC and SY as well as NET and their interconnection.

Here, 7 digital communication devices DC(TN1) to DC(TN7) are shown, wherein as digital communication devices there may be mentioned: smartphones, mobile phones, tablets, PCs, notebooks, servers, telephones, voice over IP devices. For some devices that may not be directly suitable for the procedure, such as older mobile phones or older fixed-line phones, additional devices such as PCs or appropriately configured intermediate devices can be integrated to ensure smooth synchronization of events.

The devices are all connected to a computer-supported synchronization center SY via a network connection NET, such as the Internet or a telephone network.

In FIG. 3, a more detailed schematic representation of the process flow of the inventive method of synchronization is presented.

In this version, three subscribers TN2, TN3 and TN4 are to synchronize an event with a first subscriber TN1.

The first subscriber TN1 (of course also the other subscribers) transmits their subscriber status S[TNx] to the computer-supported synchronization center SY on a quasi-continuous basis, so that at least the current subscriber status S[TNx] is known to the computer-supported synchronization center SY. As in this example of execution, a subscriber status profile SP[TNx] is preferably transmitted by the first subscriber TN1 to the computer-supported synchronization center SY, whereby the subscriber status profile SP[TNx] informs the computer-supported synchronization center SY of upcoming subscriber statuses and their changes in the future.

The three subscribers TN2, TN3 and TN4 transmit the corresponding requests for an event with the addition that the status of the requested subscriber should be TN1 S[TN1]=2 (for TN2 and TN4) or S[TN1]=1 (for TN3).

After the received transmission of event requests E by the computer-supported SY synchronization center, they are stored in subscriber-specific event tables ET[TNx] and then, if all the necessary prerequisites have been appropriately adapted, the respective events E take place.

In FIG. 4, a first schematic representation of a representation of an or the inventive method of synchronization is shown on a display DCD of a digital communication device DC.

Using for example a smartphone as a digital communication device DC, the DCD display consists of a touchscreen display that can be operated by fingers, with the display having at least two areas to the left and right of the vertical dashed line.

The left-hand part shows the subscriber status profile SP[TNx], wherein the computer-supported synchronization center SY displays preplanned events in the respective status S[TNx] of the subscriber TNx as circles or spheres. The representation of the pre-planned events includes, among other things, the duration, i. e. large circles mean a longer event duration and small circles mean a shorter event duration, the importance of the events for the subscriber TNx can be represented using colors, wherein the importance can be determined by the computer-based synchronization center SY.

The right-hand part of the screen shows events E1, E2, E3 and E4 that have already been scheduled, for example, fixed events of a station TNx. These events can be telephone calls, meetings and the like.

The subscriber TNx now has the possibility to get a complete overview of his day, i. e. when and in which status events are pending, so he can deal with them.

Furthermore, it is possible to change the pre-synchronized events in their sequence by moving them, whereby corresponding changes are transferred to the computer-supported synchronization center SY and a corresponding check is made to see whether the necessary requirements can still be met, which are necessary for the execution of the event.

Furthermore, the computer-supported synchronization center SY can be used to evaluate and display events, which is also shown on the display.

By clicking on an event E, further detailed information can be displayed so that the subscriber TNx gets a complete overview of all upcoming events.

As time progresses, events E and status S move downwards, so that a constant view into the future is always possible, thus giving people the feeling that they are not chasing after the events and activities, but that they are accompanied by the events and the tasks and activities associated with them.

Alternatively, a corresponding time bar can also be used to scroll through the day, of course scrolling over the next few days is possible.

Events are offered or are already scheduled, wherein there are flexible events and also fixed events.

FIG. 5 shows a second schematic representation of a representation of an or the inventive method of synchronization on a display DCD of a digital communication device DC. In this display variant, the events E and the status S[TNx] of the subscriber TNx are represented in the form of a circle, whereby, for example, one day is always displayed and preset status S[TNx] is symbolized, wherein the events E1 to E8 are displayed on these areas.

The time hand tp moves clockwise accordingly. Incompletely scheduled events that have not yet been synchronized are entered in the display from below, and precisely then, when synchronization is possible.

Of course, the subscriber also has the possibility to move events manually.

The two display variants are called Prestream.

### REFERENCE CHARACTER LIST

CO chronological order
DBS database system
DC digital communication device, smartphone, mobile phone, tablet, PC, notebook, server, telephone, VoIP device
DCD display on the digital communication device
E event (time synchronized asynchronous/asynchronous to be synchronized)
E1, E2, E3 event, scheduled
ECT probable event time, estimated call time
ET event table of the events
ET[TN1], ET[TN2], ET[TNx] subscriber-specific event table of the subscribers TN1, TN2, TNx
ID[TNx] reference number of the subscriber TNx
NET network connection, Internet
PT[TNx] property/parameters, place of residence, interests, skills, profession, business index, . . . of the subscriber TNx
S[E] event status
S[TNx] subscriber status of the subscriber TNx wherein:
   1=business,
   2=private,
   3=rest mode/sleep/emergency only/no communication
SP[TNx] subscriber status profile of the subscriber TNx
SY computerized synchronization center
t time
T communication time window with subscriber status S[TNx]
TE event time window for event E with duration t
TGx[TNm, . . . , TNn] group of subscribers TNm, . . . , TNn
tp time hand
TN1, TN2, TNx attendees
TS status overlap time

1. A method of synchronizing between at least two subscribers (TN1, TN2, TNx) of at least one asynchronous event (E) between the subscribers (TN1, TN2, TNx) to time-synchronized events (E),
having the steps:
digitally transmitting an event request (E) from a first subscriber (TN1) to a computer-based synchronization center (SY), the event request (E) having at least the following parameters:
reference number of the first subscriber (ID[TN1]),
time window (TE[TN1]) for the occurrence of the asynchronous event (E),
identity (TN2) and/or a referencing number (ID[TN2]) and/or at least one assignable/referenceable parameter and/or property (PT[TN2]) of the at least second subscriber (TN2),
event status (S[E]), which must correspond to the subscriber status (S[TN2], S[TNx]) of the at least second subscriber (TN2, TNx) or all subscriber statuses (S[TN1], S[TN2], S[TNx])) of all subscribers (TN1, TN2, TNx) selected to carry out the event,
referencing of the event (E) according to the event request (E) of the first subscriber (TN1) by the computer-based synchronization center (SY) taking into account the transmitted parameters;
entering the event (E) in an event table (ET) within the computer-based synchronization center (SY);
checking and recording the subscriber status (S[TN1], S[TN2], S[TNx])) and/or checking for change of the subscriber status (S[TN1], S[TN2], S[TNx]);
ongoing and/or repetitive checking of the events (E) of the event table (ET) for agreement and/or fulfilment and/or fulfilability of the parameters of the events (E) of at least the necessary subscribers (TN1, TN2, TNx) for the event, wherein in the case of agreement and/or fulfilment and/or fulfilability of the parameters at least one digital transmission of the now possible event is made to the subscribers (TN1, TN2, TNx) of the event (E) taking place and the event is synchronized.

2. The method of synchronizing between at least two subscribers (TN1, TN2, TNx) at least one asynchronous event (E) between the subscribers (TN1, TN2, TNx) to temporally synchronized events (E), in particular according to claim 1,
wherein
a computer-based synchronization center (SY) with
at least one database system (DBS) is provided, and
at least one event table (ET) and/or at least one subscriber-specific event table (ET[TN1], ET[TN2], ET[TNx]) is stored in the database system (DBS) and events (E) are assigned to relevant subscribers (TNx) in this event table (ET, ET[TNx]);
each subscriber (TN1, TN2, TNx) has at least one digital communication device (DC), the digital communication device (DC) being connectable and/or connected at least temporarily to the computer-based synchronization center (SY) via a network connection (NET);
each subscriber (TN1, TN2, TNx) or a group of subscribers (TGx[TNm, . . . , TNn]) is assigned at least one referencing number (ID[TNx/TGx]), which is stored in the computer-based synchronization center (SY) and/or the database system (DBS) and connected to a subscriber (TNx) and/or a group of subscribers (TGx[TN], . . . , TNn]);
each subscriber (TNx) is associated with a time-changeable/selectable/configurable/plannable and/or calculable subscriber status (S[TNx]) and/or a subscriber status profile (SP[TNx]), wherein the subscriber status (S[TNx]) and/or the subscriber status profile (SP[TNx]) can be selected and/or stored by the subscribers (TNx) via the digital communication device (s) (DC), wherein at least the actual or the most recent selected subscriber status (S[TNx]) or the subscriber status profile (SP[TNx]) of all subscribers (TNx) is stored in the computer-based synchronization center (SY) and/or database system (DBS), wherein the subscriber status (S[TNx]) could assume at least two different states and is at least appropriately selected from the state: private, business, do not disturb, family, VIP, home, office, occupied, temporally limited stop, and/or free,
wherein at least upon change in the subscriber status (S[TNx]) a determination, transmission/forwarding/communication and/or checking of the subscriber status (S[TNx]) or the subscriber status profile (SP[TNx]) takes place;
comprising the steps:
digital transmission and/or sending of an event request (E) from a first subscriber (TN1) by means of the digital communication device of the first subscriber (DC[TN1]) to the computer-based synchronization center (SY) with at least the following parameters:
the reference number of the first subscriber (ID[TN1]);
a time window (TE[TN1]) for the occurrence of the asynchronous event (E);
the identity (TN2) and/or a reference number (ID[TN2]) and/or at least one assignable/referenceable parameter and/or property (PT[TN2]) of the at least second subscriber (TN2), and
the event status (S[E]), which must correspond to the subscriber status (S[TN2], S[TNx])) selected for carrying out the event of the at least second subscriber (TN2, TNx) or all subscriber statuses (S[TN1], S[TN2], S[TNx])) of all subscribers (TN1, TN2, TNx);
determination of the at least second subscriber (TN2) by the computer-based synchronization center (SY) via the information of the identity and/or the referencing number (ID) or at least one assignable/referenceable parameter/property (PT) transmitted by the first subscriber (TN1);
entering the asynchronous event (E) in the event table (ET) and/or the event table(s) (ET[TN1], ET[TN2], ET[TNx]):
checking and recording the subscriber status (S[TN1], S[TN2], S[TNx])) and/or checking for change of the subscriber status (S[TN1], S[TN2], S[TNx]));
continuous and/or repetitive checking of the events (E) of the event table (ET) for agreement and/or fulfilment and/or fulfilability of the parameters of the events (E) of at least the necessary subscribers (TN1, TN2, TNx) for the event (E), wherein
upon occurrence of agreement and/or fulfilment and/or fulfilability of the parameters at least one digital transmission of the now possible event (E) occurs by the computer-based synchronization center (SY) to the digital communication devices (DC[TNx]) of the subscribers (TN1, TN2, TNx) participating in the event and the event (E) is synchronized;
and/or
at least one digital transmission of the possible event (E) by the computer-based synchronization center (SY) to the digital communication devices (DC[TNx]) of the subscribers participating in the event (TN1, TN2, TNx) is carried out and the event (E) is pre-synchronized, wherein the ongoing and/or repetitive checking of the event (E) is continued by the computer-based synchronization center (SY) until the event (E) is synchronized.

3. The method of synchronizing according to claim 1, wherein an event time window (TE[E]) and/or a chronological order (CO) for the event (E) is determined by the computer-based synchronization center (SY) and/or the database system (DBS), wherein at least the following steps are carried out for this purpose:
checking and/or determining the next possible status overlap time (TS[S[E]-S[TNx]), for which at least the subscriber status (S[TN2], S[TNx]) of the at least second subscriber (TN2, TNx) or the subscriber status (S[TN1], S[TN2], S[TNx]) of the subscribers (TN1, TN2, TNx) correspond to the event status (S[E]), wherein this checking and/or determining can be or is carried out anew in case of change in subscriber status (S[TN1], S[TN2], S[TNx]) of at least one of the subscribers (TN1, TN2, TNx), wherein:
in the case of a status overlapping time (TS[S[E]-S[TNx]) and free time within the status overlapping time (TS[S[E]-S[TNx]), the event is entered in the event table as a synchronized event with specification of an event time window (TE[aE/sE]) taking into account the free time in the event table and/or subscriber-specific event tables and/or is digitally transmitted by the computer-based synchronization center (SY) to the event participants via their digital communication devices (DC[TNx]);
without the existence of a status overlapping time (TS[S[E]-S[TNx]) or a free time within the time window (TE[TN1]) for the taking place of the asynchronous event (E) as an asynchronous event (E), the event (E) is marked as yet to be synchronized and/or is sent as a request to the at least second subscriber (TN2, TNx) by a digital transmission of the event, in particular as a request for confirmation via the computer-based synchronization center (SY) to the digital communication devices (DC[TNx]) of the at least second subscriber (TN2, TNx).

4. The method of synchronizing according to claim 1, characterized in that wherein when determining a time window (T[TN1-TN2]) for the event (E) to be synchronized, at least one prioritization of the event to be synchronized and subsequently an indexing into events already entered in the relevant subscribers event tables (ET[TN1], ET[TN2], ET[TNx] occurs,
wherein
as required a prioritization of the already synchronized events (E) takes place and/or
an event (E) to be synchronized shifts one or more events (s) already synchronized and entered in the event tables of the subscribers (ET[TN1], ET[TN2], ET[TNx]) back in time, if its priority is higher than the priority of the events (E) already entered in the event tables of the subscribers (ET[TN1], ET[TN2], ET[TNx]).

5. The method of synchronizing according to claim 4, wherein events are prioritized with at least the following parameters:
predefined priority of the event from the point of view of the at least one requesting subscriber (TN1);
prespecified event status (S[E]), wherein each subscriber status has a corresponding value;
as well as other selectable/presettable optional parameters:
a predefined priority of the event from the point of view of the at least one requested subscriber (TN2, TNx),
a VIP status of the subscriber (s),
an average evaluation by the invited subscriber (TN1), wherein the average evaluation includes at least the last 10 to 20 event evaluations, wherein an event evaluation at the end of an event which has taken place is queried by the synchronization center (SY) of the event participant subscribers, and an event evaluation is made available by the subscribers taking into account at least one of the evaluation criteria of the synchronization center (SY):
reliability of the use of the method of synchronization over the past time, wherein the time of use of the method of synchronization is registered in the synchronization center (SY);
quality of the event's content by allocating a personal evaluation on a content quality scale defined by the synchronization center (SY);
benefit and result of the event by assigning a personal evaluation on a benefit and result scale specified by the synchronization center (SY);
subscriber index, optionally according to individual subscriber status, wherein the subscriber index includes the total event evaluations;
subscriber group index, optionally according to individual subscriber status, wherein the subscriber group index includes the total event evaluations;
number of events executed;
number of multi-subscriber events executed, wherein a higher prioritization occurs with increasing number of multi-subscriber events performed;
regularly recurring events, wherein two subscribers (TN1, TN2) between which events are frequently synchronized are given higher priority;
earliest possible time of the event as specified by the requesting subscriber (TN1);
latest possible time of the event as specified by the requesting subscriber (TN1);
average duration of the requesting subscriber (TN1) in the required event log of the past/a period;
confirmation status of subscribers, wherein the synchronization center can request events and wait for their confirmation, and a large number of requests that have not yet been confirmed leads to a reduction in priority;
length of time between an event request and an event confirmation;
planned duration of the event; average duration of past events between the planned subscribers;
past observance of the planned duration of the event or the planned duration of the event with a tolerance or mutual consent for the extension of the event;
local proximity of the subscribers, with a higher prioritization of regionally more populated subscribers;
business function of a/the subscriber (TN1, TN2, TNx), in particular selectable from the appropriate functions of business supervision, management, specialist, sales, service;
correspondence of the subscribers' languages;
the quality of any necessary technical digital transmission path;
agreement of personal interests, offers, products, resources of the subscribers (TN1, TN2, TNx)
integration and/or use of personal future planning of the subscriber (s) and information provided to the synchronization center (SY).

6. The method of synchronizing according to claim 1, wherein for the event to be synchronized, a probable event time (ECT) is determined, during which the participants of the event will have time, wherein determining the probable event time comprises at least the following parameters:
earliest possible time for the event (E) as specified by the first (TN1) and/or all subscribers (TN1, TN2, TNx);
latest possible time for the event (E) as specified by the first (TN1) and/or all subscribers (TN1, TN2, TNx);
current subscriber status (S[TNx]) of the subscribers (TN1, TN2, TNx) and planned duration of the current subscriber status
as well as other selectable/presettable optional parameters:
known switching time to the required subscriber status (S[TNx]) taking into account set changeover times, day/week/vacation/absence planning;
average duration of an event of the subscriber (s) (TN1, TN2, TNx), based on the events of the subscriber (s) that have been carried out so far (TN1, TN2, TNx) and/or the events that have been carried out so far between the subscribers relevant for the event (TN1, TN2, TNx);
expected switching time to the required subscriber status (S[TNx]) of the subscribers, whereby for this an evaluation is carried out on the basis of the subscriber status history (S[TNx]) and/or the subscriber status profile (SP[TNx]);
a prioritization of the event—as specified by the subscriber (s) (TN1, TN2, TNx) and/or determined in accordance with the procedure referred to in claim 5;
availability of the subscriber (TN2, TNx) taking into account the responsiveness of the previously performed events;
location of subscribers (TN1, TN2, TNx) and/or planned locations;
number of subscribers (TN1, TN2, TNx);
time remaining within the day;
time remaining within the day for the necessary event status;
time zone of the subscribers (TN1, TN2, TNx);
workload of the subscribers (TN1, TN2, TNx), whereby an evaluation of at least the working/relaxation hours is carried out as a work-life balance ratio;
tolerance of subscribers for prolongation/reduction/exceedance of events and/or subscriber status (S[TNx]).

7. The method of synchronizing according to claim 1, wherein the subscriber status (S[TNx]) or the subscriber status profile (SP[TNx]) of one or more subscribers (TNx) is determined for future times by the computer-based synchronization center (SY) on the basis of the past subscriber status (S[TNx]) or a subscriber status profile (SP[TNx]) from the past.

8. The method of synchronizing according to claim 1, wherein the subscriber status (S[TNx]) is set manually by the subscriber himself, by externally locally positioned transmitters, person-carried transmitters taking into account subscriber-specific physical characteristics and/or body conditions, geo-tagging, varying in time and/or by other subscribers.

9. The method of synchronizing according to claim 1, wherein subscriber-specific events (E) are transmitted and/or requested automatically via the digital communication device (DC) of a subscriber (TN1) to the computer-based synchronization center (SY) on the basis of the personal subscriber status (S[TN1])/subscriber condition, the events (E) for this purpose being transmitted at least by the digital communication device (DC) and/or at least one additional device with sensor and/or detection device for the subscriber specific condition, health, and/or a subscriber specific situation and/or a subscriber specific situation, and corresponding subscriber specific (TN1) parameters/characteristics of the subscriber (TN1) for the event (e) are transmitted to the computer-based synchronization center (SY) as well as parameters/characteristics of the second subscriber (TN2, TNx).

10. The method of synchronizing according to claim 1, wherein events (E) are predetermined by the computer-based synchronization center (SY), wherein for this at least one subscriber (TN1) receives a suggestion from at least one other subscriber (TN2, TNx) as the result of digitally sending a topic- and/or parameter-related event request with predetermined topics/parameters, and for this purpose at least the following parameters are used:
evaluation of successful events (E), in which, for the evaluation of an event (E), each event (E) after completion by at least the two subscribers (TN1, TN2, TNx) is mutually evaluated, in particular an evaluation on a scale from 0 to 5 being provided and/or the average of the evaluation of the last events;
and optionally further selectable/presettable parameters selected from:
number of times per day in the last weeks a subscriber has been in one and/or more statuses (S[TNx]);
regionality, whereby contacts in the closer range, especially up to 20 km, are given a higher weighting;
number of events without postponing/rejecting (E), with a smaller number being preferred;
duration of the planned event (E), wherein shorter events (E) receive a higher priority;
adherence to planned event duration, in particular with adherence to a tolerance;
agreement in terms of topics, interests and interests identified and/or specified by the subscribers;
agreement with relevant issues or interests identified by the computerized synchronization center (SY);
available resources for the event (E), available times and/or available resources of offered services of the proposed subscriber (TN2, TNx);
same sector or services for the sector of the proposed subscriber (TN2, TNx);
quality/relevance of the events (E), services and/or resources;
offer of paid services, such as call minutes and/or service per minute.

11. The method of synchronizing according to claim 1, wherein before the synchronization of the event (E) or during the event (E) a payment for a service during the event (E) and/or a payment for the event (E) is agreed to between the subscribers (TN1, TN2, TNx) with the aid of the digital communication devices (DC).

12. The method of synchronizing according to claim 1, wherein a representation of the subscriber-specific events (E) is carried out on the subscriber-specific digital communication devices (DC[TNx]) in such a way that events (E) are represented at least in a partial area of a display of the digital communication device (DC), wherein
fixed and/or scheduled events (E) are displayed chronologically on a time scale and/or on a time line,
optionally events (E) and/or event requests which have not yet been synchronized and/or event requests, in particular events which have been given priority, prioritized, suggested in time and/or events which have been given priority by the computer-assisted synchronization center (SY), and/or events which have been given priority in a predetermined order and/or time, are shown blended in next to the fixed and/or scheduled events.

13. The method of synchronizing according to claim 12, wherein the representation of the events (E) takes place as a circle and/or sphere, preferably with a colour design, pictures, texts, indication of valences and/or other evaluation parameters, wherein different sizes of the individual event representations preferably stand for the importance of the event.

14. Representation of a method of synchronization and/or individual steps of a method of synchronization according to claim 1 on a digital communication device (DC), wherein at least in a portion of the display of the digital communication device (DC) a future-oriented time/time scale with events is represented, wherein the events (E) are temporally fixed, flexible and/or proposed by a computer-based synchronization center (SY).

15. Subscriber directory for a method of synchronization according to claim 1, wherein the subscriber directory is digitally stored in a computer-based synchronization center (SY), wherein subscribers (TN1, TN2, TNx) are stored by means of a referencing number (ID[TNx]), and parameters/properties of the subscribers (TN1, TN2, TNx) are provided, wherein the parameters/properties are modifiable by the computer-based synchronization center (SY) via at least individual method steps of a method of synchronization according to claim 1.
